(19) United States
(12) Patent Application Publication
(10) Pub. No.: US 2026/0073123 A1
(43) Pub. Date: Mar. 12, 2026

(54) METHOD AND APPARATUS FOR SUMMARIZING MEETING MINUTES USING GENERATIVE ARTIFICIAL INTELLIGENCE

(71) Applicant: SAMSUNG SDS CO., LTD., Seoul (KR)

(72) Inventors: Jeongho KIM, Seoul (KR); Jae-Wook LEE, Seoul (KR); Dongho CHA, Seoul (KR); Youngkwang KIM, Seoul (KR)

(73) Assignee: SAMSUNG SDS CO., LTD., Seoul (KR)

(21) Appl. No.: 19/242,493

(22) Filed: Jun. 18, 2025

(30) Foreign Application Priority Data
Sep. 12, 2024 (KR) 10-2024-0125005
Oct. 30, 2024 (KR) 10-2024-0150924

(51) Int. Cl. G06F 40/166; G06F 16/334; G06F 40/284; G06F 40/40

(52) U.S. Cl. CPC G06F 40/166; G06F 16/3344; G06F 40/284; G06F 40/40

(57) ABSTRACT

The disclosure relates to a generative AI-based meeting minutes summarization method and apparatus. A generative AI (artificial intelligence)-based meeting minutes summarization method using a computing device according to an embodiment of the disclosure may include: collecting transcript texts generated during a meeting to generate data chunks for every configured unit; generating summary data, when the data chunks are generated, by summarizing the transcript texts included in the data chunks using a large language model (LLM); and generating, when a query is input, summarized meeting minutes by collecting the summary data generated up to the time at which the query is input.

### CROSS-REFERENCE TO RELATED APPLICATION(S)

This application is based on, and claims priority under 35 U.S.C. 119 to, Korean Patent Applications No. 10-2024-0125005, filed on Sep. 12, 2024, and No. 10-2024-0150924, filed on Oct. 30, 2024, in the Korean Intellectual Property Office, the disclosures of which are hereby incorporated by reference in their entirety.

### BACKGROUND OF THE INVENTION

### 1. Field of the Invention

The disclosure relates to a generative AI-based meeting minutes summarization method and apparatus for automatically generating meeting minutes using transcripts from video conferences.

### 2. Description of the Prior Art

A video conferencing service is a service similar to a physical meeting, which enables multiple participants to share voice and video by displaying the video transmitted and received through a network on each participant's screen.

Recently, a function of automatically creating meeting minutes by utilizing generative AI (artificial intelligence) has been applied to video conferencing services. This meeting minutes creation function is a function of appropriately summarizing the main content of the meeting, which may create meeting minutes, based on media data such as video or voice data received from the respective terminals.

Here, if the transcript volume is large, it may be difficult to create meeting minutes due to limited input tokens of a large language model (LLM), so a separate parallel processing technique may be used. However, even with parallel processing, problems such as timeouts due to delays may occur if the transcript exceeds a certain size.

In addition, it is common to create meeting minutes when a user enters a query about the meeting. However, in this case, the calls to the large language model for generating meeting minutes may be concentrated in a specific time zone, and problems in which the so called large language model performs duplicate operations may occur.

### SUMMARY OF THE INVENTION

The disclosure is to provide a generative AI-based meeting minutes summarization method and apparatus capable of automatically generating meeting minutes using transcripts from video conferences.

The disclosure is to provide a generative AI-based meeting minutes summarization method and apparatus capable of preventing calls to the large language model from being concentrated at a specific time for generation of meeting minutes by distributing the times of calling the large language models.

The disclosure is to provide a generative AI-based meeting minutes summarization method and apparatus capable of shortening the response time to a user's query by pre-summarizing multiple pieces of data chunks obtained by dividing the transcript.

A generative AI (artificial intelligence)-based meeting minutes summarization method using a computing device according to an embodiment of disclosure may include: collecting transcript texts generated during a meeting to generate data chunks for every configured unit; generating summary data, when the data chunks are generated, by summarizing the transcript texts included in the data chunks using a large language model (LLM); and generating, when a query is input, summarized meeting minutes by collecting the summary data generated up to the time at which the query is input.

Here, the generating of the summary data may include calling the large language model each time the data chunk is generated, thereby distributing times of calling the large language model for generating the summary data.

Here, the configured unit may be a time for collecting the transcript text or the number of words in the transcript text.

Here, the generating of the summary data may include, in a case where the number of pieces of the generated summary data is equal to or more than a configured number, re-summarizing the summary data into the configured number using the large language model to generate interim summary data.

Here, the generating of the summarized meeting minutes may include collecting summary data generated after the interim summary data and the interim summary data to generate the summarized meeting minutes.

Here, the generative AI-based meeting minutes summarization method according to an embodiment of the disclosure may further include generating a response corresponding to the query using the summary data.

Here, the generative AI-based meeting minutes summarization method according to an embodiment of the disclosure may further include, when a request for modification of the transcript text is input, modifying the transcript text in the data chunk to generate a modified data chunk, and regenerating the summary data by summarizing the modified data chunk using the large language model.

Here, the generating of the summarized meeting minutes may include classifying the summary data by topic and filtering it by the topic to generate the summarized meeting minutes.

A generative AI (artificial intelligence)-based meeting minutes summarization method using a computing device according to another embodiment of the disclosure may include: collecting transcript texts generated during a meeting to generate data chunks for every configured unit; generating summarized meeting minutes, when the data chunks are generated, by summarizing the transcript texts included in the data chunks using a large language model (LLM); and summarizing, when the data chunk is added, transcript text included in the added data chunk using the large language model, and updating the summarized meeting minutes to reflect the transcript text.

Here, the updating of the summarized meeting minutes may include calling the large language model each time the data chunk is added, thereby distributing times of calling the large language model for updating the summarized meeting minutes.

A computer program according to an embodiment of the disclosure may be stored in a medium for executing, in combination with hardware, the generative AI-based meeting minutes summarization method described above.

A generative AI (artificial intelligence)-based meeting minutes summarization apparatus according to an embodiment of the disclosure may include a processor, and the processor may be configured to: collect transcript texts generated during a meeting to generate data chunks for every configured unit; generate summary data, when the data chunks are generated, by summarizing the transcript texts included in the data chunks using a large language model (LLM); and generate, when a query is input, summarized meeting minutes by collecting the summary data generated up to the time at which the query is input.

Here, in generating the summary data, the large language model may be called each time the data chunk is generated, thereby distributing times of calling the large language model for generating the summary data.

Here, wherein the configured unit may be a time for collecting the transcript text or the number of words in the transcript text.

Here, the processor may be further configured to re-summarize, in a case where the number of pieces of the generated summary data is equal to or more than a configured number, the summary data into the configured number using the large language model to generate interim summary data.

Here, in generating the summarized meeting minutes, summary data generated after the interim summary data and the interim summary data may be collected to generate the summarized meeting minutes.

Here, the processor may be further configured to generate a response corresponding to the query using the summary data.

Here, the processor may be further configured to modify, when a request for modification of the transcript text is input, the transcript text in the data chunk to generate a modified data chunk, and regenerate the summary data by summarizing the modified data chunk using the large language model.

Here, in generating the summarized meeting minutes, the summary data may be classified by topic and filtered by the topic to generate the summarized meeting minutes.

In addition, the above-mentioned solutions to problems do not list all the features of the disclosure. The various features of the disclosure and the advantages and effects thereof will be understood in more detail with reference to the specific embodiments below.

According to the generative AI-based meeting minutes summarization method and apparatus according to an embodiment of the disclosure, it is possible to automatically generate meeting minutes using transcripts from video conferences.

According to the generative AI-based meeting minutes summarization method and apparatus according to an embodiment of the disclosure, it is possible to prevent calls to the large language model from being concentrated at a specific time for generation of meeting minutes by distributing the times of calling the large language models. That is, it is possible to reduce system resources required when the calls to the large language model are concentrated at a specific time.

According to the generative AI-based meeting minutes summarization method and apparatus according to an embodiment of the disclosure, it is possible to pre-summarize multiple pieces of data chunks obtained by dividing the transcript, thereby shortening the response time to a user's query.

According to the generative AI-based meeting minutes summarization method and apparatus according to an embodiment of the disclosure, since multiple pieces of data chunks obtained by dividing the transcript can be pre-summarized and stored, it is possible to minimize redundant calls to the large language model. That is, the efficiency of use for the large language model can be increased and the cost can be reduced.

However, the effects obtainable from generative AI-based meeting minutes summarization method and apparatus according to the embodiments of the disclosure are not limited to those mentioned above, and other effects that are not mentioned will be clearly understood by those skilled in the art to which the disclosure belongs from the description below.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram schematically illustrating a meeting minutes summarization system according to an embodiment of the disclosure;

FIG. 2 is a block diagram illustrating a meeting minutes summarization apparatus according to an embodiment of the disclosure;

FIG. 3 is a diagram schematically illustrating an operation of a meeting minutes summarization apparatus modifying transcript text according to an embodiment of the disclosure;

FIG. 4 is a diagram schematically illustrating meeting minutes summarization based on MapReduce;

FIG. 5 is a diagram schematically illustrating meeting minutes summarization based on MapReduce using a meeting minutes summarization apparatus according to an embodiment of the disclosure;

FIG. 6A is a graph illustrating an LLM usage distribution in a unit of time depending on meeting minutes summarization when applying MapReduce according to an embodiment of the disclosure;

FIG. 6B is a graph illustrating an LLM cumulative usage depending on meeting minutes summarization when applying MapReduce according to an embodiment of the disclosure;

FIG. 7 is a diagram schematically illustrating meeting minutes summarization based on Refine;

FIG. 8 is a diagram schematically illustrating meeting minutes summarization based on Refine using a meeting minutes summarization apparatus according to an embodiment of the disclosure;

FIG. 9 is a graph illustrating a user response time depending on the size of a data chunk when applying Refine according to an embodiment of the disclosure;

FIG. 10 is a block diagram illustrating a computing environment suitable for use in exemplary embodiments of the disclosure;

FIG. 11 is a flowchart illustrating a generative AI-based meeting minutes summarization method according to an embodiment of the disclosure; and

FIG. 12 is a flowchart illustrating a generative AI-another embodiment of the disclosure.

### DETAILED DESCRIPTION OF THE EXEMPLARY EMBODIMENTS

Hereinafter, the embodiments disclosed in this specification will be described in detail with reference to the attached drawings. Regardless of the reference numerals, identical or similar elements will be assigned the same reference numerals, and redundant descriptions thereof will be omitted. The terms “module” and “unit” used for elements in the following description are assigned or used interchangeably only for the convenience of drafting the specification, and do not have distinct meanings or roles in themselves. That is, the term “unit” used in the disclosure indicates software or a hardware element such as FPGA or ASIC, and the “unit” performs a certain role. However, the “unit” is not limited to software or hardware. The “unit” may be configured to reside in an addressable storage medium or may be configured to reproduce one or more processors. Accordingly, as an example, “units” include elements such as software elements, object-oriented software elements, class elements, and task elements, processes, functions, properties, procedures, subroutines, segments of program code, drivers, firmware, microcode, circuits, data, databases, data structures, tables, arrays, and variables. The functions provided by the elements and “units” may be combined into a smaller number of elements and “units” or may be further divided into additional elements and “units.”

In addition, in describing the embodiments disclosed in this specification, a detailed description of a related known technology, which may obscure the subject matter of the embodiments disclosed in this specification, will be omitted. In addition, the attached drawings are only intended to facilitate easy understanding of the embodiments disclosed in this specification, and the technical ideas disclosed in this specification are not limited to the attached drawings, and should be understood to include all modifications, equivalents, or substitutes included in the scope of the disclosure.

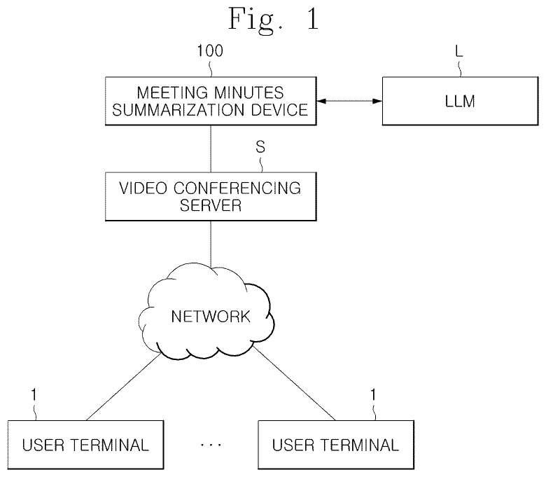

FIG. 1 is a diagram schematically illustrating a meeting minutes summarization system according to an embodiment of the disclosure.

FIG. 1 shows a meeting minutes summarization system according to an embodiment of the disclosure, which may include a user terminal 1, a video conferencing server S, a large language model (LLM) (hereinafter referred to as LLM) L, and a meeting minutes summarization apparatus 100.

Hereinafter, a meeting minutes summarization system according to an embodiment of the disclosure will be described with reference to FIG. 1.

The user terminal 1 may access the video conferencing server S using a wired or wireless network and receive video conferencing services through the video conferencing server S. A user may transmit media data including video or voice using the user terminal 1 and receive media data such as video or voice transmitted from the other party's user terminal 1 through the video conferencing server S, thereby performing a video conference. Although FIG. 1 shows that the user terminal 1 performs a video conference with another user terminal 1 through the video conferencing server S, the video conference may also be performed through P2P (Peer-to-Peer) communication between the user terminals 1 depending on the embodiment.

The user terminal 1 may be equipped with a communication module for transmitting and receiving information, a memory for storing programs and protocols, and a processor for executing various programs to perform computation and control. In addition, the user terminal 1 may further include devices for performing a video conference, such as cameras, microphones, speakers, and displays. Here, the respective devices may be provided in the user terminal 1 or connected to the user terminal 1 by wired or wireless communication.

The user terminal 1 may be a mobile terminal such as a smartphone or tablet PC, or a fixed terminal such as a desktop PC. For example, the user terminal 1 may include a mobile phone, a smartphone, a laptop computer, a digital broadcasting terminal, a personal digital assistant (PDA), a portable multimedia player (PMP), a slate PC, a tablet PC, an ultra-book, a wearable device (e.g., a smartwatch, smart glasses, or a head-mounted display (HMD)), or the like.

The network may include a wired network and a wireless network and, specifically, may include various networks such as a local area network (LAN), a metropolitan area network (MAN), and a wide area network (WAN). In addition, the network may include the World Wide Web (WWW) as known in the art. However, the network according to the disclosure is not limited to the networks listed above, and may include a known wireless data network, a known telephone network, a known wired or wireless television network, or the like.

The video conferencing server S may provide video conferencing services between the user terminals 1. The video conferencing server S may relay the transmission of media data between the user terminals 1 or perform configuration for P2P communication between the user terminals 1. That is, the video conferencing server S may perform a relay function of receiving respective pieces of media data transmitted by the user terminals 1 and transmitting the same to a corresponding user terminal 1, or may provide configuration information or the like for the user terminals 1 to transmit media data to each other through P2P communication.

Here, the media data may include video data or voice data generated during a video conference. For example, the video data may include a video shot by a camera of the user terminal 1 during a video conference, or a screen sharing video of a screen displayed on a display unit in the user terminal 100 during screen sharing. In addition, the voice data may include the user's voice, ambient sound, or sound effects input through a microphone of the user terminal 1.

The meeting minutes summarization device 100 may generate meeting minutes by summarizing and organizing the content of a meeting, based on media data transmitted by the user terminals 1 through a video conference. Here, the meeting minutes summarization device 100 may receive media data from the video conferencing server S, which has been transmitted by the user terminals 1, and generate summarized meeting minutes, based on this.

The meeting minutes summarization device 100 may include resources such as a processor and a memory, and may provide services such as meeting minutes generation based on generative AI (artificial intelligence) using the same. Here, the meeting minutes summarization device 100 may have various models built based on generative AI, and may perform operations such as natural language processing in association with the LLM L using the generative AI model. The LLM L may be, for example, GPT (Generative Pre-trained Transformer), LLAMA (Large Language Model Meta AI), etc., and in addition, various types of LLMs L may be utilized depending on the embodiment.

Specifically, the meeting minutes summarization device 100 may automatically generate meeting minutes for a video conference, based on generative AI, and, when a query is input from the user terminal 1, generate and provide, based on the generated meeting minutes, an appropriate response based on natural languages.

Although FIG. 1 illustrates the meeting minutes summarization device 100 as a separate component from the video conferencing server S, the meeting minutes summarization device 100 and the video conferencing server S may be implemented as a single component depending on the embodiment. That is, the meeting minutes summarization device 100 may be implemented to include the functions of the video conferencing server S. In addition, depending on the embodiment, the meeting minutes summarization device 100 may separately receive the recording of a corresponding meeting and also generate the summarized meeting minutes, based on the recording.

Meanwhile, in the case of summarizing the transcript of a meeting using Gen AI and responding to a user's query, based on the summarized meeting minutes, a feature vector may be preferentially generated by embedding the transcript and then the feature vector and the original transcript may be stored in a database. That is, the feature vector may be generated and stored in advance so as to provide a response corresponding to the transcript, based on RAG (Retrieval-Augmented Generation).

Afterwards, if a user requests a summary of the meeting content or sends a query about the meeting content, summarized meeting minutes may be generated from the original transcript stored in the database, and data may be selected according to the similarity with the query using the feature vector, thereby generating a response based on the LLM.

In this case, if the transcript volume is large, it may be difficult to perform processing due to limited input tokens of the LLM, so a response or summary to the query may be generated utilizing parallel processing techniques such as Refine or MapReduce. However, even in the case of parallel processing, if the transcript exceeds a certain size, the number of input tokens capable of being processed by the LLM L may be exceeded, causing a timeout due to delay or the like.

In addition, in the case of starting processing of the transcript when a user inputs a query or summary request, if different users attending the meeting input queries for the same transcript, respectively, the LLM L may repeat the same operation. That is, since the same operation must be performed repeatedly, the overall process may be inefficient. In addition, since there may be cases where calls to the LLM L are concentrated in a specific time zone, there is also a problem that a high-performance operating system is required.

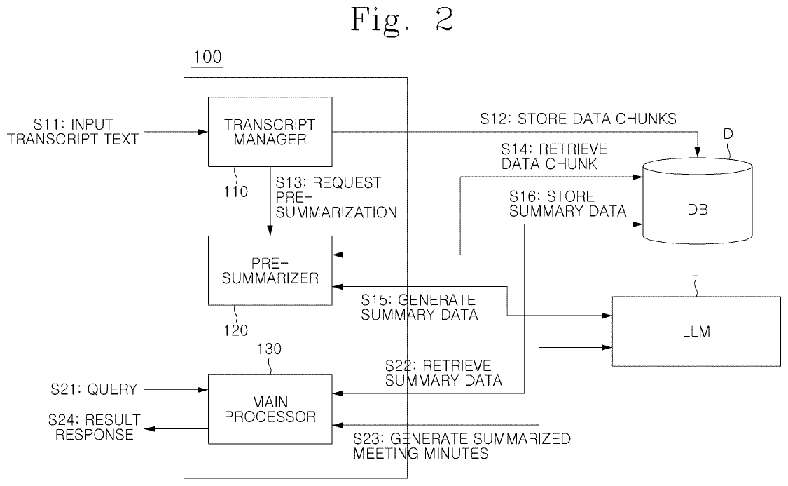

Accordingly, the meeting minutes summarization apparatus 100 according to an embodiment of the disclosure may summarize the transcript in advance and store it in the database at the time of storing the transcript in the database. In this case, if a summary request or query is received from the user, the query for the LLM may be processed based on summary data that has already been summarized, instead of the original transcript. Therefore, it is possible to distribute the times of calling the LLM and shorten the response time to the user's request. Hereinafter, the meeting minutes summarization apparatus 100 according to an embodiment of the disclosure will be described with reference to FIG. 2.

FIG. 2 is a block diagram illustrating a meeting minutes summarization apparatus according to an embodiment of the disclosure. Referring to FIG. 2, a meeting minutes summarization apparatus 100 according to an embodiment of the disclosure may include a transcript manager 110, a pre-summarizer 120, and a main processor 130.

The transcript manager 110 may collect transcript text generated during a meeting and generate data chunks for every configured unit. Specifically, the transcript manager 110 may receive transcript text obtained by converting user speech collected during a meeting into text, based on STT (Speech-to-Text) (S11). That is, the transcript manager 110 may collect transcript texts input in real time during the meeting, and generate a transcript by combining the transcript texts in chronological order. Here, the transcript may be continuously updated by sequentially input transcript texts, and it is also possible to receive transcripts for already finished meetings depending on the embodiment.

The transcript manager 110 may collect respective input transcript texts and generate data chunks for every configured unit, and may store the generated data chunks in a database D (S12). At this time, the configured unit may be a time for collecting transcript text, the number of words included in the transcript text, a file size of the transcript text, or the like.

Specifically, each transcript text may further include information as metadata about the time at which the speech corresponding to the corresponding transcript text was recorded, and this may be used to identify information about the time at which each speech was made. In this case, the transcript manager 110 may configure the configured unit to a certain time (e.g., 3 minutes) and collect transcript texts corresponding to the users' speech during the time and generate one data chunk.

In addition, since the maximum number of input tokens capable of being processed by the LLM L is fixed, the configured unit may be the number of words included in the data chunk by reflecting the same. That is, when transcript texts corresponding to a preset number of words are collected, a new data chunk may be generated. For example, in the case where the maximum number of input tokens of the LLM L is 4000 tokens, since one word takes up about 1 to 2 tokens on average, 4000 tokens may correspond to 2000 to 3000 words. Here, although one data chunk may be configured to include 2000 to 3000 words, the number of words included in the data chunk may be appropriately adjusted in consideration of the performance of the LLM L. That is, the number of words may be configured to be large for the LLM L to sufficiently understand the content, but not to be so large, thereby preventing the quality of summary data for the data chunk from deteriorating. For example, the transcript manager 110 may configure the configured unit so that one data chunk includes 500 to 1,500 words, thereby generating each data chunk. However, it is not limited thereto, and the number of words included in one data chunk may be adjusted in various ways depending on the embodiment.

After that, the transcript manager 110 may store the generated data chunk in the database D (S12). That is, data chunks may be generated from the input transcript texts, and the generated data chunks may be stored in the database D. However, depending on the embodiment, it is also possible to preferentially store the received transcript texts in the database D, and then generate respective data chunks from the stored transcript texts. Here, the transcript manager 110 may perform embedding on the input transcript text to generate each feature vector corresponding thereto and store the generated feature vector in the database D. In this case, the database D may also include a separate vector database for storing feature vectors.

When the data chunk is generated, the pre-summarizer 120 may generate summary data by summarizing the transcript texts included in the data chunk using the LLM L. In other words, the pre-summarizer 120 may generate summary data for the data chunk in advance at the time at which the corresponding data chunk is generated, before a user's query or the like is input.

Depending on the embodiment, when each data chunk is generated, the transcript manager 110 may transmit a pre-summarization request to the pre-summarizer 120 (S13), and the pre-summarizer 120 may retrieve a corresponding data chunk from the database in response to the received pre-summarization request (S14) and input the retrieved data chunk into the LLM L, thereby requesting generation of summary data (S15). Here, the pre-summarizer 120 may request the generation of summary data by inputting the retrieved data chunk into the LLM L together with a preset prompt, and the LLM L may provide summary data corresponding to the corresponding data chunk. Thereafter, the pre-summarizer 120 may store the summary data generated by the LLM L in the database D. At this time, the database D may display and store respective data chunks corresponding to the summary data. Here, since the pre-summarizer 120 calls the LLM L every time the data chunk is generated, the times of calling the LLM L for generating the summary data may be distributed. That is, by calling the LLM L in a distributed manner before a user request is input, summary data for respective data chunks may be generated in advance.

In addition, in the case where the number of pieces of generated summary data is equal to or more than a configured number, the pre-summarizer 120 may re-summarize the summary data into the configured number using the LLM L, and may generate interim summary data through this. That is, in the case where the number of pieces of summary data exceeds the configured number, it may exceed the maximum number of input tokens capable of being processed by the LLM L. Therefore, the pre-summarizer 120 may generate, when the number of pieces of summary data reaches the configured number, interim summary data obtained by pre-summarizing the same once more, thereby preventing the maximum number of input tokens of the LLM L from being exceeded.

When a query is input from the user, the main processor 130 may collect the summary data generated up to the time at which the query is input and generate summarized meeting minutes. In addition, depending on the embodiment, a result response may be generated and provided based on the summarized meeting minutes. Specifically, when a query is received from the user (S21), the main processor 130 may retrieve summary data from the database D and request the LLM L to generate summarized meeting minutes using the summary data (S23). At this time, the main processor 120 may request the generation of summarized meeting minutes by inputting the retrieved summary data, along with a preset prompt, into the LLM L, and LLM L may generate and provide summarized meeting minutes corresponding to the summary data. Thereafter, the main processor 130 may generate a response corresponding to the user's query, based on various Gen AI models such as RAG, using the generated summarized meeting minutes.

Additionally, when interim summary data is generated in the pre-summarizer 120, the main processor 130 may collect summary data generated after the interim summary data and the interim summary data to generate summarized meeting minutes. That is, since the summary data corresponding to the data chunks before the interim summary data is already reflected in the interim summary data, the summary data generated before the interim summary data may be omitted. Therefore, the pre-summarizer 120 may collect and summarize interim summary data and summary data generated after that, thereby finally generating summarized meeting minutes.

In addition, since summary data for respective data chunks is pre-stored in the database, an embodiment utilizing this is also possible. For example, the main processor 130 or the pre-summarizer 120 may classify respective pieces of summary data stored in the database D by topic, and some of the summary data may be filtered and removed in advance depending on the topic. For example, if the topic of some summary data is small talk about the weather or current situation, this may be considered as content unrelated to the actual meeting content. Therefore, the main processor 130 or the pre-summarizer 120 may perform topic classification on the summary data stored in the database D, and then filter out unnecessary content in advance. Through this, it is possible to generate high-quality summarized meeting minutes with unnecessary content such as small talk removed.

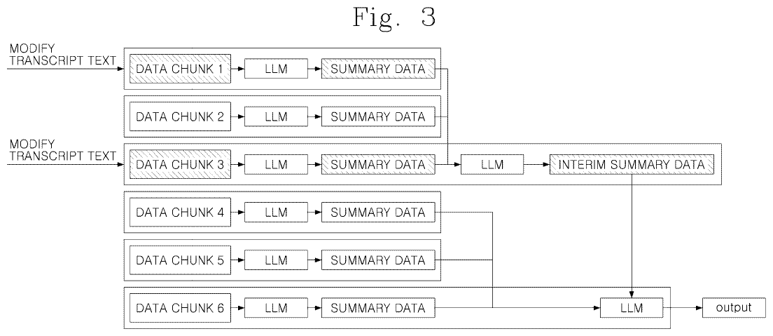

Meanwhile, depending on the embodiment, a request for modification of transcript text may be received. For example, since transcript text generated based on STT may contain errors, modification may be performed to correct them. In this case, it is necessary to modify not only the transcript text stored in the database D, but also the summary data generated in advance based on it. That is, as shown in FIG. 3, when performing modification on the transcript texts included in data chunk 1 and data chunk 3, it is necessary to modify both the summary data and the interim summary data generated according thereto.

Specifically, when a modification request is entered, the transcript text in the data chunk may be modified to generate a modified data chunk, and summary data may be regenerated by summarizing the modified data chunk using the LLM L, and the regenerated summary data and the modified data chunk may be stored in the database D. In addition, in the case where interim summary data is generated, the interim summary data may also be regenerated and stored based on the regenerated summary data.

In general, when performing meeting minutes summarization using the LLM L, techniques such as Stuff, Refine, and MapReduce may be utilized.

Stuff is a method of generating corresponding summarized meeting minutes by inputting the entire transcript into the LLM L at once, which may be applied to the case where the amount of the entire transcript is not large. However, it may be difficult to apply Stuff to the case where the meeting is long, and parallel processing techniques such as Refine or MapReduce may be utilized.

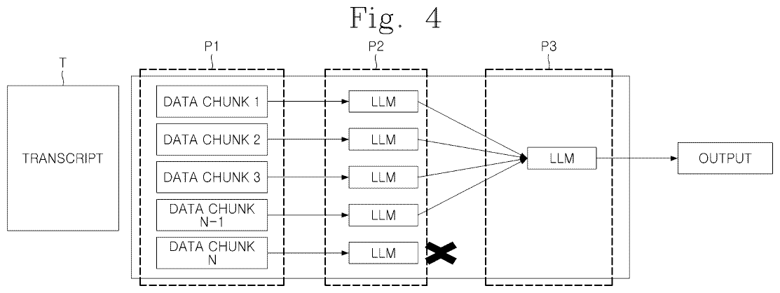

MapReduce may be a method of generating summarized meeting minutes by splitting input data such as a huge transcript into multiple data chunks, performing summarization on the respective data chunks in a distributed manner by a plurality of LLMs, and merging the summary results performed by the respective LLMs into one. That is, as shown in FIG. 4, the transcript T may be split into small data chunks and stored in a distributed file system such as HDFS (Hadoop Distributed File System) in the split step P1, and the respective data chunks may be processed simultaneously by a plurality of LLMs in the map step P2, and the data processed in the respective machines may be combined to finally generate summarized meeting minutes in the reduce step P3. In this way, by utilizing MapReduce, the respective data chunks may be distributed through a plurality of LLMs and processed in parallel in the map stage P2, so it is possible to minimize the latency for the user's query.

However, when generating a summarized transcript from the respective pieces of summary data using the LLM in the reduce stage P3, the summary data may exceed the maximum number of input tokens of the LLM. That is, when the number of data chunks is large, the number of pieces of summary data input to the LLM also may increase and exceed the maximum number of input tokens of the LLM. In this case, as illustrated in FIG. 4, there may be a problem in which the summary data for data chunk N is omitted when generating a summarized transcript.

In addition, even when utilizing MapReduce, if the summarization of the transcript is performed when a query is input from the user, the problem may occur that the LLM usage is concentrated at a specific time. That is, since multiple LLMs must be called simultaneously, there is a problem in which a high-performance system is required to implement the meeting minutes summarization apparatus 100.

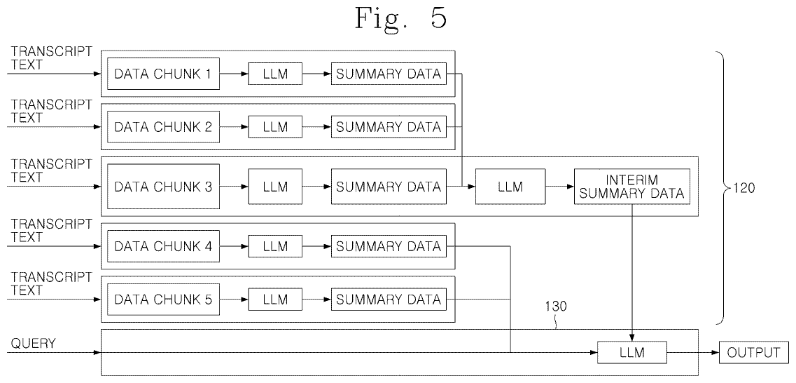

Accordingly, in the meeting minutes summarization apparatus 100 according to an embodiment of the disclosure, when applying MapReduce, as illustrated in FIG. 5, the transcript manager 110 may generate a data chunk each time each transcript text is input, and the pre-summarizer 120 may call the LLM to generate summary data for each data chunk. In this case, the times of calling the LLM may be distributed, thereby solving the problems in which the peak usage of the LLM increases at the time at which a user's query is input.

In addition, as illustrated in FIG. 5, in the case where the number of pieces of generated summary data is equal to or more than a configured number (e.g., 3), the pre-summarizer 120 may re-summarize the summary data into the configured number using the LLM L, thereby generating interim summary data. That is, in the case where the number of pieces of summary data exceeds the configured number, it may exceed the maximum number of input tokens capable of being processed by the LLM. Therefore, the pre-summarizer 120 may generate, when the number of pieces of summary data reaches the configured number, interim summary data obtained by pre-summarizing the same once more, thereby preventing the maximum number of input tokens of the LLM L from being exceeded.

Afterwards, the main processor 130 may call the LLM once to generate a response to the user's query, thereby shortening the response time to the user's query and preventing the LLM usage from being concentrated at the time at which the user's query is received.

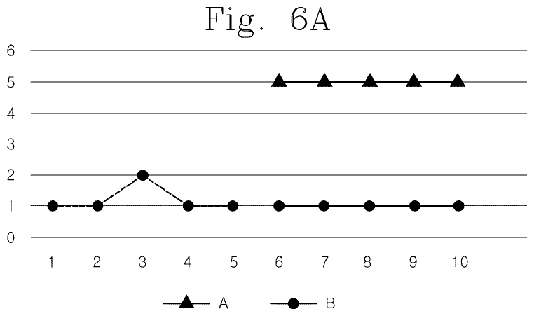

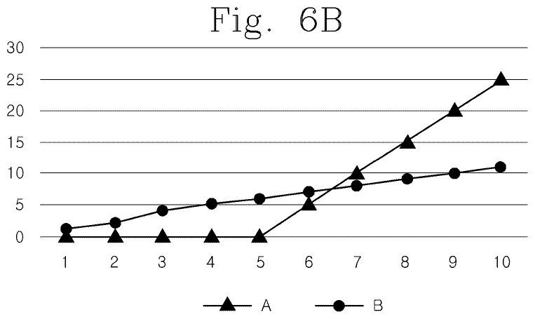

FIG. 6 illustrates graphs of an LLM usage distribution in a unit of time and an LLM cumulative usage during meeting minutes summarization according to an embodiment of the disclosure. Referring to FIG. 6A, in the prior art A, it can be confirmed that, when generating summarized meeting minutes by MapReduce, the LLM is not used initially, but that the LLM is called 5 times simultaneously at the time point (6th time point) at which the user's query is input. On the other hand, in the case B in which the meeting minutes summarization apparatus 100 according to an embodiment of the disclosure is used, it can be confirmed that the LLM is called one to two times (2 times correspond to the case of generating interim summary data) at the 1st to 5th time points before the user's query is input, and then is called once again when the user's query is input. That is, it can be confirmed that the peak usage of the LLM is reduced by distributing the usage time of the LLM in time.

In addition, FIG. 6B shows the cumulative usage of LLM, and it can be confirmed in the prior art A that the LLM is not used initially, but the cumulative usage increases rapidly from the time point (6th time point) at which the user's query is input. On the other hand, in the case B where the meeting minutes summarization apparatus 100 according to an embodiment of the disclosure is used, although the LLM is used when the user does not input a query, the LLM usage does not increase rapidly like in the prior art A after the user inputs a query, and it is possible to reduce the cumulative usage compared to the prior art A. That is, it may be confirmed that the use of the meeting minutes summarization apparatus 100 according to an embodiment of the disclosure is more advantageous when a user's query is input.

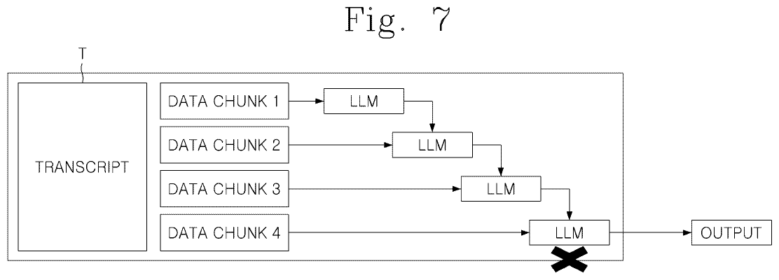

Meanwhile, in the case of Refine, as shown in FIG. 7, the transcript T may be split into multiple data chunks, and summarized meeting minutes may be repeatedly generated using respective data chunks, thereby generating the final summarized meeting minutes. That is, the first data chunk may be summarized by the LLM to generate summarized meeting minutes, and then the next data chunk may be summarized again by the LLM so that the summarized meeting minutes may be updated to include the content thereof. By repeating this for all data chunks, the summarized meeting minutes for the entire transcript T may be finally generated.

Here, in process of Refine, since the summarization is repeated using the LLM, it is possible to generate high-quality summarized meeting minutes. However, in the case where the summarized meeting minutes for the stored transcript T are generated based on Refine when the user inputs a query, long latency may occur due to the sequential processing of the LLM, resulting in a timeout that prevents a response from being provided to the user.

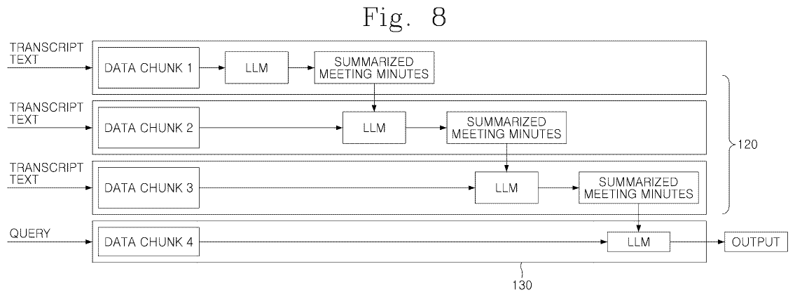

Accordingly, in the meeting minutes summarization apparatus 100 according to an embodiment of the disclosure, the transcript manager 110 may generate data chunks whenever each transcript text is input, as shown in FIG. 8, when Refine is applied. Here, the pre-summarizer 120, when the data chunk is generated, may generate summarized meeting minutes by summarizing the transcript texts included in the data chunk using the LLM. Afterwards, when a data chunk is added by the transcript manager 110, the pre-summarizer 120 may summarize the transcript text in the added data chunk again using the LLM to update the summarized meeting minutes to reflect the transcript text.

That is, since the pre-summarizer 120 calls the LLM each time the data chunk is added, the times of calling the LLM for updating the summarized meeting minutes may be distributed. In addition, since the pre-summarizer 120 generates the summarized meeting minutes in advance when the data chunk is added, it is possible to solve problems such as timeout due to the latency that occurs when Refine is applied.

Meanwhile, when a query is input from a user, the main processor 130 may generate and provide a result response, based on the generated summarized meeting minutes. That is, in the case of Refine, since the pre-summarizer 120 has already generated the entire summarized meeting minutes and stored the same in the database at the time at which the data chunk is generated, the main processor 130 may generate a response to the user's query, based on various Gen AI models such as RAG, using the summarized meeting minutes. At this time, the main processor 130 may generate a response to the query through a single call to the LIM, so it is possible to drastically reduce the latency compared to the existing Refine.

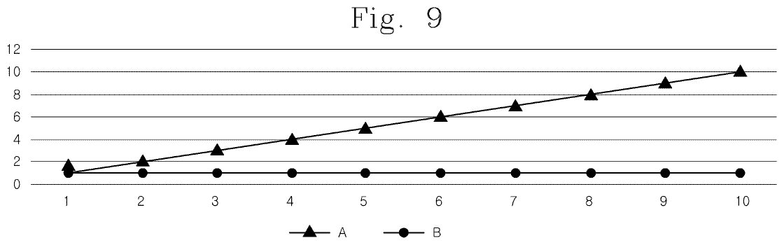

FIG. 9 is a graph illustrating a user response time depending on the size of a data chunk when applying Refine according to an embodiment of the disclosure. Referring to FIG. 9, it can be confirmed in the prior art A that as the size of the data chunk increases (x-axis), the user response time increases proportionally (y-axis). On the other hand, in the case B of using the meeting minutes summarization apparatus 100 according to an embodiment of the disclosure, it can be confirmed that the user response time remains constant (y-axis) even when the size of the data chunk increases (x-axis).

Here, although the case where Refine and MapReduce are applied to the meeting minutes summarization apparatus 100 according to an embodiment of the disclosure is exemplified, the disclosure is not limited thereto. That is, the meeting minutes summarization apparatus 100 according to an embodiment of the disclosure may be utilized to generate meeting minutes by applying various parallel processing techniques other than Refine or MapReduce.

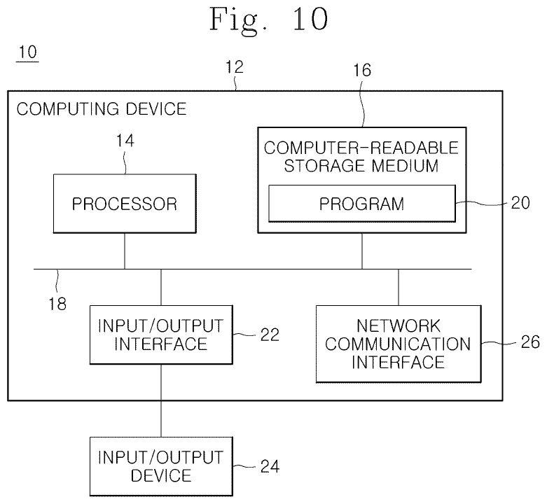

FIG. 10 is a block diagram illustrating a computing environment 10 suitable for use in exemplary embodiments of the disclosure. In the illustrated embodiment, respective components may have other functions and capabilities, in addition to those described below, and may further include other components in addition to those described below.

The illustrated computing environment 10 includes a computing device 12. In an embodiment, the computing device 12 may be a generative AI-based meeting minutes summarization apparatus 100.

The computing device 12 includes at least one processor 14, a computer-readable storage medium 16, and a communication bus 18. The processor 14 may cause the computing device 12 to operate according to the embodiments described above. For example, the processor 14 may execute one or more programs stored on a computer-readable storage medium 16. The one or more programs may include one or more computer-executable instructions, which may be configured to cause, when executed by the processor 14, the computing device 12 to perform operations according to the embodiments. The computer-readable storage medium 16 is configured to store computer-executable instructions, program code, program data, and/or other suitable forms of information. The program 20 stored on the computer-readable storage medium 16 includes a set of instructions executable by the processor 14. In an embodiment, the computer-readable storage medium 16 may be memory (volatile memory, such as random-access memory, nonvolatile memory, or a suitable combination thereof), one or more magnetic disk storage devices, optical disk storage devices, flash memory devices, another type of storage medium capable of being accessed by the computing device 12 and storing desired information, or a suitable combination thereof.

The communication bus 18 interconnects various components of the computing device 12, including the processor 14 and the computer-readable storage medium 16.

The computing device 12 may also include one or more input/output interfaces 22 that provide interfaces for one or more input/output devices 24, and one or more network communication interfaces 26. The input/output interfaces 22 and the network communication interfaces 26 are connected to the communication bus 18. The input/output devices 24 may be connected to other components of the computing device 12 via the input/output interfaces 22. The exemplary input/output devices 24 may include input devices such as a pointing device (mouse, trackpad, etc.), a keyboard, a touch input device (touchpad, touchscreen, etc.), a voice or sound input device, various types of sensor devices and/or photographing devices, and/or output devices such as a display device, a printer, a speaker, and/or a network card. The exemplary input/output device 24 may be included inside the computing device 12 as a component that constitutes the computing device 12, or may be configured as a separate device distinct from the computing device 12 and then connected to the computing device 12.

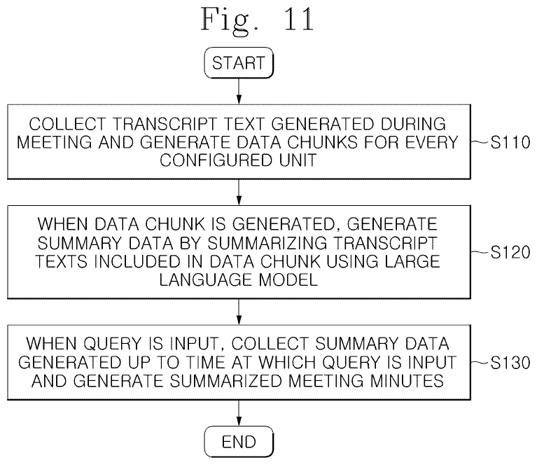

FIG. 11 is a flowchart illustrating a generative AI-based meeting minutes summarization method according to an embodiment of the disclosure. Here, the respective steps shown in FIG. 11 may be performed by a meeting minutes summarization apparatus or a computing device according to an embodiment of the disclosure.

Referring to FIG. 11, the computing device may collect transcript text generated during a meeting and generate data chunks for every configured unit (S110). The computing device may receive transcript text obtained by converting user speech collected during a meeting into text, based on STT. That is, the computing device may collect transcript text input in real time during the meeting.

The computing device may collect respective input transcript texts and generate data chunks for every configured unit, and may store the generated data chunks in a database. At this time, the configured unit may be a time for collecting transcript text, the number of words included in the transcript text, a file size of the transcript text, or the like.

Specifically, each transcript text may further include information, as metadata, about the time at which the speech corresponding to the corresponding transcript text was recorded, and this may be used to identify information about the time at which each speech was made. In this case, the transcript manager 110 may configure the configured unit to a certain time (e.g., 3 minutes) and collect transcript texts corresponding to the users' speech during the time and generate one data chunk.

In addition, since the maximum number of input tokens capable of being processed by the LLM is fixed, the configured unit may be configured as the number of words included in the data chunk by reflecting the same. That is, when transcript texts corresponding to a preset number of words are collected, the computing device may generate a new data chunk.

When the data chunk is generated, the computing device may generate summary data by summarizing the transcript texts included in the data chunk using the LLM (S120). That is, the computing device may generate summary data for the data chunk in advance at the time at which the corresponding data chunk is generated, before a user's query or the like is input.

Depending on the embodiment, the computing device may retrieve a corresponding data chunk from the database in response to a pre-summarization request transmitted when each data chunk is generated, and input the retrieved data chunk into the LLM, thereby generating the summary data. Here, the computing device may request the generation of summary data by inputting the retrieved data chunk into the LLM together with a preset prompt, and the LLM may provide summary data corresponding to the corresponding data chunk. Thereafter, the computing device may store the summary data generated by the LLM in the database. Here, since the computing device calls the LLM every time the data chunk is generated, the times of calling the LIM for generating the summary data may be distributed. That is, by calling the LLM in a distributed manner before a user request is input, summary data for respective data chunks may be generated in advance.

Additionally, in the case where the number of pieces of generated summary data is equal to or more than a configured number, the computing device may re-summarize the summary data into the configured number using the LLM and generate interim summary data through this. That is, in the case where the number of pieces of summary data exceeds the configured number, it may exceed the maximum number of input tokens capable of being processed by the LLM. Therefore, the computing device may generate, when the number of pieces of summary data reaches the configured number, interim summary data obtained by pre-summarizing the same once more, thereby preventing the maximum number of input tokens of the LLM from being exceeded.

Afterwards, when a query is input, the computing device may collect the summary data generated up to the time at which the query is input and generate summarized meeting minutes (S130). In addition, the computing device may generate a response corresponding to the query using the summary data.

Specifically, when a query is received from the user, the computing device may retrieve summary data stored up to now from the database and request the LLM to generate summarized meeting minutes using the summary data. Afterwards, the computing device may generate a response corresponding to the user's query, based on various Gen AI models such as RAG, using the summarized meeting minutes provided from the LLM.

Here, in the case where interim summary data is generated by the computing device, the computing device may collect summary data generated after the interim summary data and the interim summary data to generate summarized meeting minutes. That is, since the summary data corresponding to the data chunks before the interim summary data is already reflected in the interim summary data, the summary data generated before the interim summary data may be omitted. Therefore, the computing device may collect and summarize interim summary data and summary data generated after that, thereby finally generating summarized meeting minutes.

In addition, since summary data for respective data chunks is pre-stored in the database, an embodiment utilizing this is also possible. For example, the computing device may classify respective pieces of summary data stored in the database by topic, and some of the summary data may be filtered and removed in advance depending on the topic. For example, if the topic of some summary data is small talk about the weather or current situation, this may be considered as content unrelated to the actual meeting content. Therefore, the computing device may perform topic classification on the summary data stored in the database, and then filter out unnecessary content in advance. Through this, it is possible to generate high-quality summarized meeting minutes with unnecessary content such as small talk removed.

Meanwhile, depending on the embodiment, a request for modification of transcript text may be input. For example, since transcript text generated based on STT may contain errors, modification may be performed to correct them. In this case, it is necessary to modify not only the transcript text stored in the database, but also the summary data generated in advance based on it. Specifically, when a modification request is input, the computing device may modify the transcript text in the data chunk to generate a modified data chunk, and generate summary data by summarizing the modified data chunk using the LLM, and the regenerated summary data and the modified data chunk may be stored in the database. In addition, in the case where interim summary data is generated, the interim summary data may also be regenerated and stored based on the regenerated summary data.

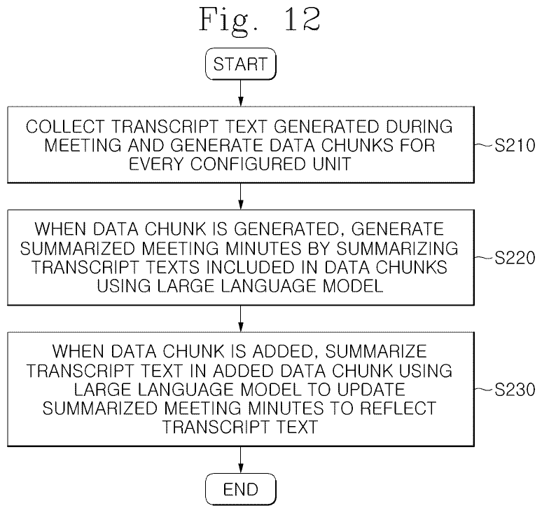

FIG. 12 is a flowchart illustrating a generative AI-based meeting minutes summarization method according to another embodiment of the disclosure. Here, the respective steps of FIG. 12 may be performed by a meeting minutes summarization apparatus or a computing device according to an embodiment of the disclosure.

Referring to FIG. 12, the computing device may collect transcript text generated during a meeting and generate data chunks for every configured unit (S210). The computing device may receive transcript text obtained by converting user speech collected during a meeting into text, based on STT. The computing device may collect respective input transcript texts and generate data chunks for every configured unit, and may store the generated data chunks in a database. At this time, the configured unit may be a time for collecting transcript text, the number of words included in the transcript text, a file size of the transcript text, or the like.

When the data chunk is generated, the computing device may generate summarized meeting minutes by summarizing the transcript texts included in the data chunks using the LLM (S220). In addition, when a data chunk is added, the computing device may summarize the transcript text in the added data chunk using the LLM to update the summarized meeting minutes to reflect the transcript text (S230). That is, since the computing device calls the LLM each time the data chunk is added, the times of calling the LLM for updating the summarized meeting minutes may be distributed.

Afterwards, when a query is input from a user, the computing device may generate and provide a result response, based on the generated summarized meeting minutes. That is, since the computing device updates the summarized meeting minutes and stores the same in the database each time the data chunk is generated, the computing device may generate a response to the user's query, based on various Gen AI models such as RAG, using the summarized meeting minutes. At this time, since the computing device continuously updates and stores the summarized meeting minutes at the time when the data chunk is added, the computing device may generate a response to the query through a single call to the LLM, based on the summarized meeting minutes. Accordingly, it is possible to drastically reduce the latency for the user's query.

The above-mentioned disclosure may be implemented as a computer-readable code on a medium in which a program is recorded. The computer-readable medium may be a medium that continuously stores a computer-executable program or temporarily stores it for execution or download. In addition, the medium may be a variety of recording means or storage means in the form of a single or multiple hardware combinations, and is not limited to a medium directly connected to a computer system, but may also be distributed on a network. Examples of the medium may include magnetic media such as hard disks, floppy disks, and magnetic tapes, optical recording media such as CD-ROMs and DVDs, magneto-optical media such as floptical disks, and ROMs, RAMs, flash memories, etc., configured to store program instructions. In addition, examples of other media include recording media or storage media managed by app stores that distribute applications, or sites or servers that supply or distribute various software. Therefore, the above detailed description should not be construed as limiting the disclosure in all respects and should be considered as examples. The scope of the disclosure should be determined by a reasonable interpretation of the appended claims, and all changes within the equivalent scope of the disclosure are included in the scope of the disclosure.

The disclosure is not limited to the above-described embodiments and the attached drawings. It will be apparent to those skilled in the art to which the disclosure belongs that components according to the disclosure may be substituted, modified, and changed without departing from the technical idea of the disclosure.

What is claimed is:

1. A generative AI (artificial intelligence)-based meeting minutes summarization method using a computing device, the method comprising:
collecting transcript texts generated during a meeting to generate data chunks for every configured unit;
when the data chunks are generated, generating summary data by summarizing the transcript texts included in the data chunks using a large language model (LLM); and
when a query is input, generating summarized meeting minutes by collecting the summary data generated up to the time at which the query is input.

2. The generative AI-based meeting minutes summarization method of claim 1, wherein the generating of the summary data comprises calling the large language model each time the data chunk is generated, thereby distributing times of calling the large language model for generating the summary data.

3. The generative AI-based meeting minutes summarization method of claim 1, wherein the configured unit corresponds to a time for collecting the transcript text or the number of words in the transcript text.

4. The generative AI-based meeting minutes summarization method of claim 1, wherein the generating of the summary data comprises, in a case where the number of pieces of the generated summary data is equal to or more than a configured number, re-summarizing the summary data into the configured number using the large language model to generate interim summary data.

5. The generative AI-based meeting minutes summarization method of claim 4, wherein the generating of the summarized meeting minutes comprises collecting summary data generated after the interim summary data and the interim summary data to generate the summarized meeting minutes.

6. The generative AI-based meeting minutes summarization method of claim 1, further comprising generating a response corresponding to the query using the summary data.

7. The generative AI-based meeting minutes summarization method of claim 1, further comprising, when a request for modification of the transcript text is input, modifying the transcript text in the data chunk to generate a modified data chunk, and regenerating the summary data by summarizing the modified data chunk using the large language model.

8. The generative AI-based meeting minutes summarization method of claim 1, wherein the generating of the summarized meeting minutes comprises classifying the summary data by topic and filtering the classified summary data by the topic to generate the summarized meeting minutes.

9. A generative AI (artificial intelligence)-based meeting minutes summarization method using a computing device, the method comprising:
collecting transcript texts generated during a meeting to generate data chunks for every configured unit;
when the data chunks are generated, generating summary data by summarizing the transcript texts included in the data chunks using a large language model (LLM); and
when the data chunk is added, summarizing transcript text included in the added data chunk using the large language model, and updating the summarized meeting minutes to reflect the transcript text.

10. The generative AI-based meeting minutes summarization method of claim 9, wherein the updating of the summarized meeting minutes comprises calling the large language model each time the data chunk is added, thereby distributing times of calling the large language model for updating the summarized meeting minutes.

11. A computer program stored in a medium for executing, in combination with hardware, the generative AI-based meeting minutes summarization method of claim 1.

12. A generative AI (artificial intelligence)-based meeting minutes summarization apparatus comprising a processor,
wherein the processor is configured to:
collect transcript texts generated during a meeting to generate data chunks for every configured unit;
when the data chunks are generated, generate summary data by summarizing the transcript texts included in the data chunks using a large language model (LLM); and
when a query is input, generate summarized meeting minutes by collecting the summary data generated up to the time at which the query is input.

13. The generative AI-based meeting minutes summarization apparatus of claim 12, wherein, in generating the summary data, the large language model are called each time the data chunk is generated, thereby distributing times of calling the large language model for generating the summary data.

14. The generative AI-based meeting minutes summarization apparatus of claim 12, wherein the configured unit corresponds to a time for collecting the transcript text or the number of words in the transcript text.

15. The generative AI-based meeting minutes summarization apparatus of claim 12, wherein the processor is further configured to, in a case where the number of pieces of the generated summary data is equal to or more than a configured number, re-summarize the summary data into the configured number using the large language model to generate interim summary data.

16. The generative AI-based meeting minutes summarization apparatus of claim 15, wherein, in generating the summarized meeting minutes, summary data generated after the interim summary data and the interim summary data are collected to generate the summarized meeting minutes.

17. The generative AI-based meeting minutes summarization apparatus of claim 12, wherein the processor is further configured to generate a response corresponding to the query using the summary data.

18. The generative AI-based meeting minutes summarization apparatus of claim 12, wherein the processor is further configured to, when a request for modification of the transcript text is input, modify the transcript text in the data chunk to generate a modified data chunk, and regenerate the summary data by summarizing the modified data chunk using the large language model.

19. The generative AI-based meeting minutes summarization apparatus of claim 12, wherein, in generating the summarized meeting minutes, the summary data is classified by topic and filtered by the topic to generate the summarized meeting minutes.
